(19) United States
(12) Patent Application Publication
(10) Pub. No.: US 2006/0098287 A1
(43) Pub. Date: May 11, 2006

(54) Diffractive optical element and optical pickup device using the same

(75) Inventors: Tetsuo Ariyoshi, Osaka-shi (JP); Ho Seop Jeong, Kyunggi-Do (KR); Soo Jin Jung, Kyunggi-Do (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd.

(21) Appl. No.: 11/114,330

(22) Filed: Apr. 25, 2005

(30) Foreign Application Priority Data
Nov. 5, 2004 (KR) 2004-89831

(51) Int. Cl. G02B 5/18; G02B 27/42

(52) U.S. Cl. 359/573; 359/558

(57) ABSTRACT

Disclosed is a diffractive optical element which can diffract incident light beams in such a controlled manner as to compatibly accommodate various optical discs of different thicknesses by an optical pickup device. Also, a simple optical pickup device provided with the diffractive optical element is disclosed.

### BACKGROUND OF THE INVENTION

1. Field of the Invention

The present invention relates to the accommodation of various optical recording media of different thicknesses by an optical pickup device. More particularly, the present invention relates to a diffractive optical element which can diffract incident light beams in such a controlled manner as to compatibly accommodate various optical discs of different thicknesses by an optical pickup device, and to a simple optical pickup device provided with the diffractive optical element.

2. Description of the Related Art

As a means for storing image and/or voice information or as a secondary memory unit for computers, optical recording media (hereinafter referred to as just “optical media”), which are now predominant over other recording media, are largely classified into compact discs (CD) with a storage capacity of 650 MB and digital versatile discs (DVD) with a storage capacity of 4.7 GB. Determining the size of information to be recorded or regenerated, the storage capacity of optical media depends on the optical spot to which a laser can be focused through an objective lens. A focused laser beam has a focal spot diameter scaling S according to the following Equation 1:
S∝λ/NA Equation 1

where λ is the wavelength of the laser beam and NA is the objective lens numerical aperture.

Hence, an increase in storage capacity is mainly enabled by reducing the spot size by using shorter wavelength light and by increasing the numerical aperture of the objective lens. Nowadays, a blue-violet laser beam is used as a short wavelength light source with an NA over 0.6. For example, as much as 22 GB can be stored by using a blue wavelength (405 nm) in combination with an NA=0.85 objective lens.

However, the high numerical aperture places a stringent constraint on disc tilt because tilt causes coma aberration, which is represented by the following equation.

$${W}_{31} = - \frac{d}{2} \frac{{n}^{2} ( {n}^{2} - 1 ) sin θ cos θ}{{( {n}^{2} - {sin}^{2} θ )}^{5 / 2}} {NA}^{3} \qquad Equation 2$$

where W₃₁ is a coma aberration, θ is a tilt angle of an optical disc, n is a refractive index of the optical disc, d is a thickness of the optical disc, and NA represents a numerical aperture of the optical disc.

Usually, the thickness of an optical disc refers to that from a light incident layer to a recording layer in the optical disc. The refractive index also refers to that measured in the above thickness range. In general, because the signal degradation due to disc tilt is in inverse proportion to the wavelength of the incident laser beam and in proportion to the cubical value of NA of the objective lens, the tolerance for disc tilt sharply decreases with an increase in storage density. In order to compensate for this, an optical disc with a high recording density is reduced in thickness. This is corroborated through Equation 2 in that, to secure a tolerance for disc tilt, disc thickness must be reduced as the numerical aperture of the objective lens is increased for high storage density. For instance, CDs which use a 780 nm beam are 1.2 mm thick, and DVDs are reduced to a thickness of 0.6 mm due to the use of a 650 nm beam. Thus, an optical disc using a blue laser, hereinafter referred to as a ‘blue-ray disc’, or ‘BD’ in abbreviation, is anticipated to be 0.1 mm thick. Of course, the numerical aperture of the objective lens is 0.45 for CDs and 0.6 for DVDS. In the case of BDs, the numerical aperture may be increased to as high as 0.85. As suh, an important problem anticipated to stem from the development of new standards of optical discs is found in the compatibility etween the new standards and pre-existing ones.

Optical discs of different thicknesses require optical pickup devices specific therefor. An optical pickup device designed for one type of optical discs cannot be applied to other types: upon application, such spherical aberrations take place as to make it impossible to normally record/regenerate signals. A variety of attempts have been made to overcome such optical degeneration and provide a compatible optical pickup which can compatibly adopt a high-density and a low-density optical disc having different thicknesses.

One technique is found in Japanese Pat. Laid-Open Publication No. 2004-158118 which discloses that an objective lens for BDs is used along with an objective lens for CD/DVDs in one pickup device. However, the employment of two objective lenses in one pickup device is disadvantageous in regards to miniaturization and production cost.

When account is taken of size, assembly convenience and cost, it is preferred that compatible optical pickup devices which employ light sources of different wavelengths have single objective lenses.

The use of a single objective lens to record data on or regenerate data from optical discs of different thicknesses causes spherical aberrations due to the difference in thickness. Therefore, compensation for spherical aberrations is needed to use different types of optical discs with a single objective lens.

A compatible optical pickup device which employs an objective lens for optical discs of different thicknesses is disclosed in Japanese Pat. Laid-Open Publication No. 2004-14095. The compatible optical pickup device which can adopt a high-density optical disc and a low-density optical disk of mutually different thicknesses is provided with an objective lens which can form an optical spot suitable for the low density recording medium by utilizing converging light in the shape of diverged light. Also, the optical pickup device shows satisfactory aberration characteristics even in the case of a shift of the objective lens in the radial direction of the optical disc without the addition of optical components to the low-density optical disc. However, the compatible pickup device suffers from a practical disadvantage in that aberrations occur with the tracking movement of the objective lens.

Another compatible optical pickup device which employs a single lens and can be used with discs of different thicknesses is disclosed in Japanese Pat. Laid-Open Publication No. 2003-91859. The optical pickup device is provided with a holographic optical element which employs a birefringence medium as a diffractive optical element. In the holographic optical element, the diffractive optical element is mounted on an actuator for an objective lens so as to move together with the objective lens, thereby restraining the aberration occurrence due to tracking motion. In addition to compensating for spherical aberration with regard to optical discs with different densities, the holographic optical element can most efficiently utilize light beams to record or reproduce data on the optical discs. However, the optical pickup device has significant drawbacks. If the diffractive optical element is optimally adapted for DVDs, CDs require a divergent light beam. In contrast, in the case of optimal adaptation of the diffractive optical element for CDs, a convergent light beam must be incident on DVDs.

As stated above, ongoing goals for future pickup devices include the removal of aberrations due to the use of short wavelength light beams in conjunction with high numerical apertures, and universal adoption of different types of optical discs. Numerous as they are, all of the solutions suggested thus far have the problem of causing the large-size and high production cost of pickup devices.

Therefore, there is needed a small-sized optical pickup device that can adopt optical discs different in thickness without the occurrence of aberration.

### SUMMARY OF THE INVENTION

Accordingly, the present invention has been made keeping in mind the above problems occurring in the prior art, and an object of the present invention is to provide a diffractive optical device which can universally adopt BDs, DVDs and CDs with the use of a single objective lens even when parallel light beams, or almost equivalent divergent or convergent light beams are incident thereon.

Another object of the present invention is to provide an optical pickup device provided with the diffractive optical element having a numerical aperture-adjusting member, which is simple in structure and excellent in operational efficiency.

In accordance with an aspect of the present invention, there is provided a diffractive optical element suitable for use in an optical pickup device capable of compatibly adopting high-density recording media and low-density recording media, wherein the diffractive optical element is divided into at least three regions by three concentric circles, and has a diffractive structure whose pitch is changed in a continuous manner in each of the regions, but in a discontinuous manner at the interfaces between the regions.

In accordance with another aspect of the present invention, there is provided a diffractive optical element as set forth in claim 4, further comprising a numerical aperture-adjusting member for providing light beams incident on the diffractive optical element with a numerical aperture suitable for low-density recording media

### BRIEF DESCRIPTION OF THE DRAWINGS

The above and other objects, features and advantages of the present invention will be more clearly understood from the following detailed description taken in conjunction with the accompanying drawings, in which:

FIG. 1 is a plan view of a diffractive optical element according to the present invention;

FIG. 2 is a side view of a diffractive optical element according to the present invention;

FIG. 3 is a cross sectional view of a diffractive optical element according to the present invention;

FIGS. 4A and 4B shows the effect of the diffraction caused by the diffractive optical element according to the present invention;

FIG. 5 shows plots of the pitch of a diffractive structure versus the radius of the diffractive optical element; and

FIGS. 6A, 6B and 6C, 7A, and 7B show the paths that the DVD and CD laser beams passing through the diffractive optical element take, respectively.

### DESCRIPTION OF THE PREFERRED EMBODIMENTS

Reference now should be made to the drawings, in which the same reference numerals are used throughout the different drawings to designate the same or similar components.

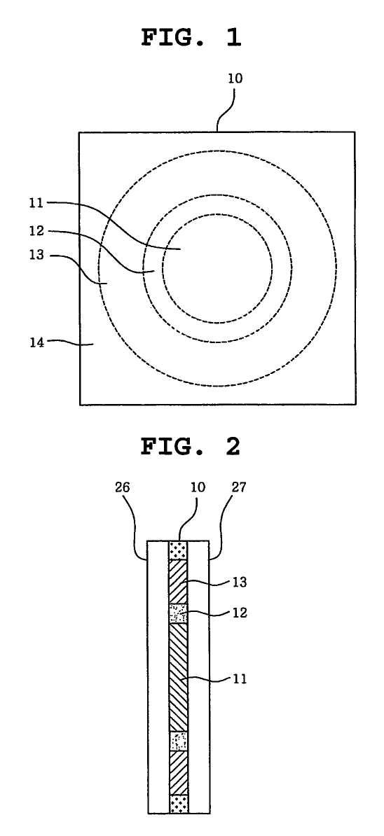

With reference to FIGS. 1 to 3, a diffractive optical element 10 of the present invention is shown in a plan view, in a side view and in a cross sectional view, respectively. As seen, the diffractive optical element 10, which is designed to compatibly adopt a high-density recording medium and at least one low-density recording medium, can be divided into three regions by three concentric circles. It comprises a pair of glass substrates 15 and 16, with a polarizing layer 17 interposed therebetween.

In an embodiment of the present invention, the low-density recording medium is described separately as a first and a second low-density recording medium: the first is of low density relative to the second. In this embodiment, the high-density recording medium is exemplified by a BD for which a laser beam with a wavelength as short as 405 nm is used in combination with a numerical aperture of 0.85. The first low-density recording medium is a CD which employs a 780 nm laser beam in combination with a numerical aperture of 0.4 whereas the second low-density recording medium is a DVD, employing a 650 nm laser beam in combination with a numerical aperture of 0.6.

Turning to FIG. 1, the diffractive optical element 10 of the present invention has three concentric regions: a first region 11, a second region 12, and a third region 13 in outward order. In the diffractive optical element 10, the outside of the third region 13 refers to an outer region 14. Of them, the first region 11 is provided for compensating for aberrations in the recording media whose thickness is between those of the first and the second low-density recording medium. The second region 12 and the third region 13 are provided for compensation for aberrations in the first low-density recording medium and the second low-density recording medium, respectively.

According to an embodiment of the present invention, the first region 11, formed in the radius range of 0<r<0.75 mm, is optimally adapted for optical discs media which are between DVD and CD in thickness, that is, have a disc thickness from 0.6 to 1.2 mm. The second region 12 is formed in the radius range of 0.75<r<0.89 mm and optimally adapted for 1.2 mm thick CDs. The third region 13 is formed in the radius range of 0.89<r<1.185 mm and optimally adapted for 0.6 mm thick DVDs. The diffractive optical element 10, as evident from the side view of FIG. 2, is so designed that light beams passing therethrough converge almost to a diffraction limit.

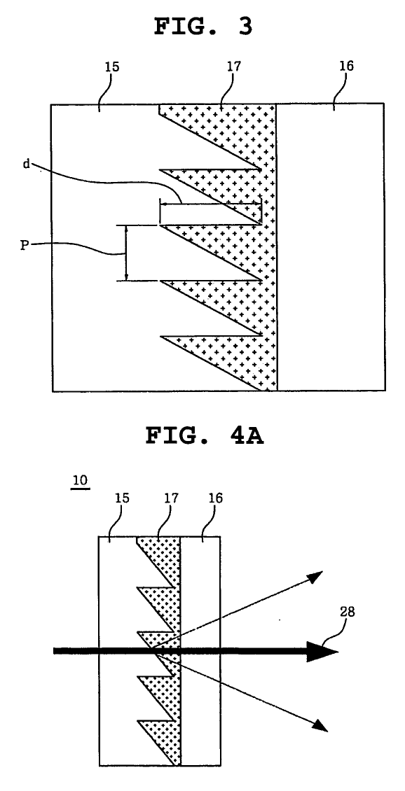

As shown in the cross sectional view of FIG. 3, the diffractive optical element 10 has a glass substrate layer 15 brazed into a saw-toothed form, a polarizing layer 17 having a flat plane and a saw-toothed face corresponding to the glass substrate layer 15 and a flat plane, and a flat glass substrate layer 16 corresponding to a flat plane of the polarizing layer 17. For compatible adoption of BD, DVD and CD, the diffractive optical element 10 is optimally adapted for BD which is the highest in recording density while allowing DVD and CD to be used by diffracting the light beams incident thereto. Once being incident on the diffractive optical element 10, all light beams, transmitted in a parallel pattern from light sources, for reproducing CD and DVD are diffracted by the diffraction plane of the diffractive optical element 10 so that their traveling paths are bent toward an objective lens, thereby compensating for aberrations due to the differences in disc thickness and wavelength.

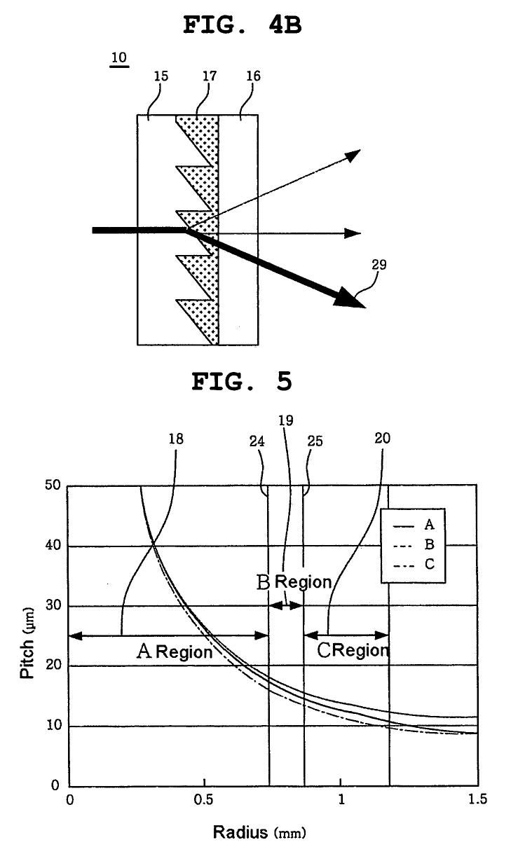

To design the diffractive optical element 10 to allow light beams to be focused to the diffraction limit, 0^{th}-order diffracted light beams (non-diffracted light beams) should be used for BDs because the diffractive optical element 10 is optimally adapted for BDs. In the case of DVDs and CDs, first-order diffracted light beams are suitable. The diffractive optical element 10, as seen in FIGS. 4a and 4b, is structured to direct 0^{th}-order diffracted light beams 28 almost exclusively toward BDs and first-order diffracted light beams 29 almost exclusively toward DVDs and CDs.

These selective directions are determined by the refractive index ng₁ and the groove depth d of the glass. The polarizing layer 17 is made of a birefringence optical material which meets the following Equation 3:
ng₁=n₁ Equation 3
d=0.655/(ng₂−n₂) (unit: um)

where ng₁ is the refractive index of the glass; n₁ is the refractive index of the birefringence material at a BD wavelength; d is the groove depth of the glass; ng₂ is the refractive index of the glass at a DVD wavelength; and n₂ is the refractive index of the birefringence material at a DVD wavelength in the direction of polarization perpendicular to that for BDs.

With no diffraction of BD wavelength, almost all CD/DVD wavelengths are diffracted in first order. The directions of polarization of BD and DVD/CD light beams must be orthogonal to each other when the polarized light beams are incident.

Instead of a birefringence material, a polymeric material which shows such large changes in refractive index according to wavelengths as to satisfy the following Equation 4 may be used for the polarizing layer 17.
ng₁=n₁ Equation 4
d=0.655/(ng₂−n₂) (unit: um)

where ng₁ is the refractive index of the glass at a BD wavelength; n₁ is the refractive index of the polymeric material at a BD wavelength; d is the groove depth of the glass; ng₂ is the refractive index of the glass at a DVD wavelength; and n₂ is the refractive index of the polymeric material at a DVD wavelength.

In this case, because the change in refractive index due to wavelength is generally small compared with the change in refractive index of the polarizing material, the groove depth of the diffractive structure becomes large. Any material satisfying Equation 4 may be used for the polarizing layer 17.

The diffractive structure of the diffractive optical element 10 is designed to have different pitches from the region to region. FIG. 5 shows plots of the pitch of the diffractive structure versus the radius of the diffractive optical element 10. In the plots, region A 18 corresponds to the first region 11, region B 19 to the second region 12, and region C 20 to the third region 13. In each region, pitches are continuously formed. The real line 21 is provided for a continuous change of pitch in the first region 11, the broken line 22 for a continuous change of pitch in the second region 12, and the dash-and-dot line 23 for a continuous change of pitch in the third region 13. That is, the pitch in each region changes in a continuous manner, but the pitch changes discontinuously at a first interface 24 between the first region 11 and the second region 12 and at a second interface 25 between the second region 12 and the third region 13. In addition, the diffractive structure of this present invention is formed in a saw-toothed form and the pitch of the diffractive structure is determined by that of the saw teeth.

In accordance with an embodiment of the present invention, the first region 11 optimally adapted for the intermediate thickness range between DVDs and CDs is confined in the radius range of 0<r<0.75 mm, the second region 12 optimally adapted for CDs in the radius range of 0.75<r<0.89 mm, and the third region 13 optimally adapted for DVDs in the radius range of 0.89<r<1.185 mm. As mentioned above, the present invention is featured by the discontinuous change of pitch at the borders r=0.75 mm and r=0.89 mm. Consequently, the division of the diffractive optical element 10 into the three regions results from the formation of different pitches in respective regions.

In one embodiment of the present invention, the groove depth d of the polarizing layer 17 is determined according to Equations 3 and 4 and the pitches are obtained from the plot of FIG. 5. The diffractive optical element 10 of the present invention allows a single objective lens to compatibly adopt the three wavelengths for BDs, DVDs and CDs.

Additionally, the diffractive optical element 10 of the present invention may further include a numerical aperture-adjusting member by which low-density recording light beams incident on the diffractive optical element 10 are provided with a numerical aperture suitable for low-density recording media.

According to an embodiment of the present invention, a numerical aperture-adjusting member for restricting the numerical aperture of the light beams for low-density recoding media is formed on each face of the diffractive optical elemnt 10. Referring to FIG. 2, a first numerical aperture-adjusting region 26 for restricting the numerical aperture of the light beams for the first low-density recording medium is formed on the front side of the diffractive optical element 10, and a second numerical aperture-adjusting region 27 for restricting the numerical aperture of the light beams for the second low-density recording medium is on the rear side of the diffractive optical element 10.

Thus, in one embodiment of the present invention, the outer region 14 outside of the third region 13, serving as the first numerical aperture-adjusting region 26 for restricting the DVD aperture, is provided for making the diffracted DVD wavelength beams unfocused on the disc by restricting the aperture of the DVD light beams passing therethrough. Likewise, in the radius range of 0.91 (um)<r on the rear side of the diffractive optical element 10, the second numerical aperture-adjusting region 27 is provided for restricting the aperture of the CD light beams passing therethrough so as to make the diffracted CD wavelength beams unfocused on the disc. These numerical aperture-adjusting members may be formed by coating multiple films on the surface of the diffractive optical element. As for the second numerical aperture-adjusting region 27 for preventing the penetration of CD wavelength, however, its formation may not exert a significant effect because, upon data reproduction from CDs, not only does a large aberration occur, but the beams are not focused on CDs.

As described above, the diffractive optical device of the present invention can restrict the CD and DVD apertures by the provision of numerical aperture-adjusting regions formed on each side in addition to being able to compatibly adopt three wavelengths for BDs, DVDs and CDs using a single objective lens, thereby leading to the realization of a simple pickup device.

A description will be given of the operations of the BD, DVD and CD light beams passing through the diffractive optical element 10, below.

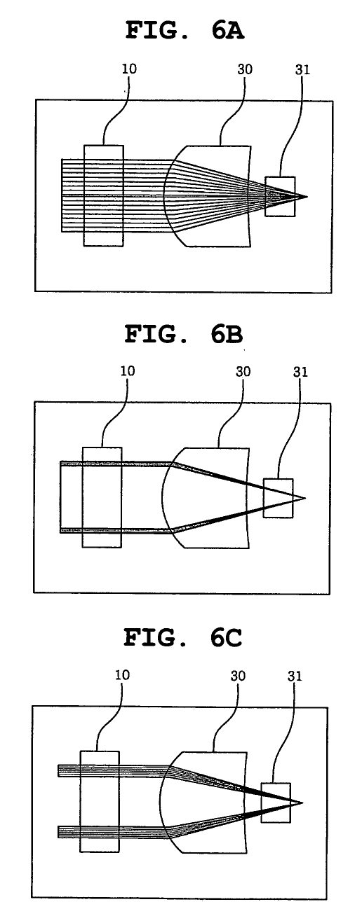

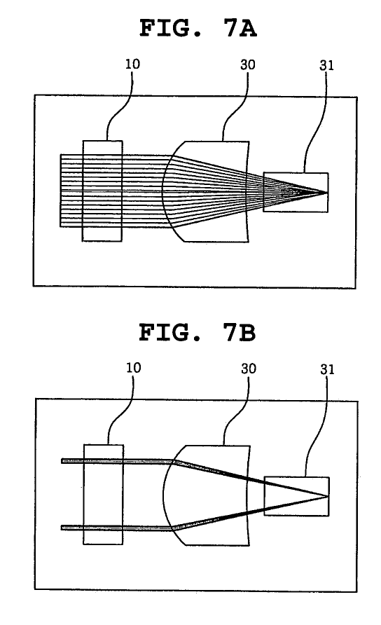

In FIG. 6, the paths of DVD laser beams passing through the diffractive optical element of the present invention are traced, and FIG. 7 shows the paths of CD laser beams.

In detail, the paths which the DVD light beams take are shown in FIG. 6a when they pass through the first region 11, in FIG. 6b when they pass through the second region 12, and in FIG. 6c when they pass through the third region 13. The aberrations generated when the light beams take the paths can be calculated according to the region. For the aberration value, 0.014 λrms was calculated in the first region 11, 0.119 λrms in the second region 12, and 0.022 λrms in the third region 13. When these aberration values are weighted by the area ratio of the regions (A:B:C=0.4:0.16:0.44), the total waterfront aberration value of approximately 0.034 λrms is obtained. This total waterfront aberration value meets not only Marechal's condition for waterfront aberration (waterfront aberration<0.07 λrms), but also the conditions for a recording system (waterfront aberration<0.033 λrms) within a tolerable error limit.

Referring to FIG. 7, the paths that CD light beams take are traced: FIG. 7a is for the CD light beams passing through the first region 11 and FIG. 7b is for the CD light beams passing through the second region 12. Upon calculating aberrations generated by the paths the light beams take, 0.029 λrms is obtained in the first region 11 and 0.01 λrms in the second region 12. When these aberration values are weighted by the area ratio of the regions (A:B=0.71:0.29), the total waterfront aberration value of approximately 0.023 λrms is obtained. This total waterfront aberration value meets not only Marechal's condition for waterfront aberration (watefront aberration<0.07 λrms), but also the conditions for a recording system (waterfront aberration<0.033 λrms) within a tolerable error limit. In the figures, numeral 30 is an objective lens and numeral 31 is a recording medium.

Therefore, an optical pickup device provided with the optical diffractive element according to the present invention can reduce waterfront aberration to an appropriate range so as to bring about a large increase in the operational efficiency, in addition to being simplified in structure by virtue of the presence of the numerical aperture-adjusting member for restricting the aperture of light beams for low-density media in the diffractive optical element.

As described hereinbefore, the present invention provides an optical pickup device which can compatibly adopt BDs, DVDs and CDs under a single objective lens by use of a specifically designed optical diffractive element. In addition, provided with a numerical aperture-adjusting member for restricting the numerical apertures of DVD and CD light beams, the optical diffractive element allows the optical pickup device to have a simple structure.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A diffractive optical element suitable for use in an optical pickup device capable of compatibly adopting high-density recording media and low-density recording media, wherein the diffractive optical element is divided into at least three regions by three concentric circles, and has a diffractive structure whose pitch is changed in a continuous manner in each of the regions, but in a discontinuous manner at the interfaces between the regions.

2. The diffractive optical element as set forth in claim 1, wherein the low-density recording media include a first low-density recording disc and a second low-density recording disc, said first low-density disc being low in density compared to said second low-density disc, one of the three regions is to compensate for aberrations due to a thickness intermediate between the first low-density disc and the second low-density disc, another is to compensate for aberrations in the first low-density recording disc, and the rest is to compensate for aberrations in the second low-density recording disc.

3. The diffractive optical element as set forth in claim 1, wherein the diffractive structure is formed in a saw-toothed form and the pitch of the diffractive structure is determined by that of the saw teeth.

4. The diffractive optical element as set forth in claim 1, wherein the diffractive optical element comprises: a glass substrate layer brazed into a saw-toothed form; a polarizing layer with a face corresponding to the saw-toothed form of the glass substrate layer and a flat face; and a flat glass substrate in close contact with the flat face of the polarizing layer.

5. The diffractive optical element as set forth in claim 4, wherein the polarizing layer is made of a birefringence optical material or a polymeric material which shows a large change in refractive index with regard to wavelengths.

6. The diffractive optical element as set forth in claim 4, wherein the polarizing layer meets the following formulas:
ng₁=n₁
d=0.655/(ng₂−n₂) (unit: um)
where ng₁ is the refractive index of the glass substrate; n₁ is a refractive index of the polarizing layer at a BD wavelength; d is a groove depth of the glass substrate; ng₂ is a refractive index of the glass substrate at a DVD wavelength; and n₂ is a refractive index of the polarizing layer at a DVD wavelength in the direction of polarization perpendicular to BD wavelength.

7. The diffractive optical element as set forth in claim 4, further comprising a numerical aperture-adjusting member for providing light beams incident on the diffractive optical element with a numerical aperture suitable for low-density recording media.

8. The diffractive optical element as set forth in claim 7, wherein the numerical aperture-adjusting member is composed of a first numerical aperture-adjusting region, formed on one side of the diffractive optical element, for restricting the numerical aperture of the light beams for the first low-density recording medium, and a second numerical aperture-adjusting region, formed on another side of the diffractive optical element, for restricting the numerical aperture of the light beams for the second low-density recording medium.

9. The diffractive optical element as set forth in claim 7, wherein the numerical aperture-adjusting member is formed by coating multiple films.
